(19) United States
(12) Patent Application Publication
(10) Pub. No.: US 2008/0224894 A1
(43) Pub. Date: Sep. 18, 2008

(54) System of Guidance of the Road

(76) Inventor: Hyun Duk Uhm, Seoul (KR)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(21) Appl. No.: 11/910,754

(22) PCT Filed: Feb. 27, 2006
(86) PCT No.: PCT/KR2006/000675

§ 371 Date: Oct. 5, 2007

(30) Foreign Application Priority Data
Apr. 18, 2005 (KR) 10-2005-0032025
Jul. 19, 2005 (KR) 20-2005-0021028

(51) Int. Cl. G08B 3/10; E01C 5/00

(52) U.S. Cl. 340/944; 404/34

(57) ABSTRACT

The present invention relates to a road guidance system, which performs RF communication between a road guidance paving block and a wireless sensing stick. The road guidance system includes a road guidance paving block (200) and a wireless sensing stick (100). The coil antenna (210) of the road guidance paving block receives externally applied radio waves, generates an induced electromotive force, and uses the induced electromotive force as its required power. The road guidance paving block (200) reads location-related information previously stored in memory depending on each operation, and transmits the location-related information to the outside through the coil antenna. The wireless sensing stick (100) provides predetermined radio waves to the road guidance paving block to activate the road guidance paving block, receives location information from the road guidance paving block, processes the location information, and outputs road guidance voice information through voice output means.

### TECHNICAL FIELD

The present invention relates, in general, to a road guidance system for visually impaired persons and, more particularly, to a road guidance system, which performs radio frequency communication between a road guidance paving block and a wireless sensing stick, thus providing information about the location at which a visually impaired person is situated, the direction of a destination, and a guidance message to the visually impaired person.

### BACKGROUND ART

A plurality of devices, including a device entitled a “paving block for guiding a visually impaired person”, disclosed in Korean Utility Model Registration No. 20-0248371, has been filed with respect to a conventional road guidance system for visually impaired persons.

Of the devices, the device entitled a “paving block for guiding visually impaired persons” is implemented so that a cover enclosure 20 having an insertion cavity formed therein to cover the surface of a paving block 10 made of cement is molded using a synthetic resin material. On the cover enclosure 20, guidance protrusions implemented with projections 21 or linear protrusions are formed.

Such a device is advantageous in that production thereof is easy compared to a structure in which guidance protrusions are directly formed on a paving block itself, installation thereof is convenient, and a cushioning effect thereof is better than that of a cement product, thereby improving the sense of touch on the device with the feet when the device is used. Further, the device is characterized in that, if the device becomes worn or damaged, part of the device can be replaced, so that the management thereof is simplified.

However, there are problems in that, since the visually impaired person cannot be provided with information about a traveling direction and information about a specific location during walking, safe walking to a destination is not guaranteed, since it is impossible to sense a dangerous region, a visually impaired pedestrian is always exposed to external dangers, and since paving blocks are located only at the end of a crossing or a platform, the life of the visually impaired person is endangered if the visually impaired person missteps.

### DISCLOSURE OF THE INVENTION

Accordingly, the present invention has been made keeping in mind the above problems occurring in the prior art, and an object of the present invention is to provide a road guidance system, which allows individual visually impaired pedestrians to easily listen to information about a current location, the direction of a destination and a guidance message in voice form, thus allowing visually impaired pedestrians to safely walk to their destinations.

Another object of the present invention is to provide a road guidance system, which provides a danger warning message to a visually impaired pedestrian when the visually impaired pedestrian enters a dangerous region, thus guiding the visually impaired pedestrian to a safe region.

In order to accomplish the above objects, the present invention provides a road guidance system for visually impaired persons, comprising a road guidance paving block for receiving externally applied radio waves through a coil antenna and generating an induced electromotive force, the road guidance paving block reading location-related information, which has been previously stored in memory depending on each operation, and transmitting the location-related information to an outside of the road guidance paving block through the coil antenna; and a wireless sensing stick for providing predetermined radio waves to the road guidance paving block to induce the road guidance paving block to be activated, receiving the location-related information from the road guidance paving block, processing the location-related information through a predetermined process and then outputting load guidance voice information through voice output means.

Preferably, the road guidance paving block may comprise a memory unit operated in response to the induced electromotive force generated through the coil antenna and adapted to store location information that can be output; the coil antenna installed in the road guidance paving block to receive predetermined radio waves from the wireless sensing stick, generate an induced electromotive force and operate in response to the induced electromotive force; and a control unit for reading the location information stored in the memory unit, and controlling transmission of the location information to the wireless sensing stick through the coil antenna.

Preferably, the road guidance paving block may comprise an antenna unit for transmitting a predetermined radio frequency to the coil antenna of the road guidance paving block to transmit the induced electromotive force, and receiving the location information; a microcomputer for controlling a decoder, which converts the location information received from the antenna unit into a digital signal and performs comparison, analysis and decoding on the digital signal using a predefined encryption algorithm, and an entire system, and outputting a corresponding control signal if necessary; a text to speech chipset or a voice synthesis unit for converting the location-related information into a road guidance voice signal and synthesizing the control signal and the road guidance voice signal in response to the control signal from the microcomputer, and outputting the synthesized road guidance voice signal; voice output means for outputting the road guidance voice signal received from the text to speech chipset or the voice synthesis unit to an external sound output device; and power supply means for supplying predetermined operating power to the microcomputer.

Preferably, the road guidance system may further comprise an externally controllable power switch placed on a handle or an end portion of the wireless sensing stick and operated so that power supplied to all of the components of the wireless sensing stick can be supplied when the wireless sensing stick comes into contact with the road guidance paving block.

Preferably, the road guidance system may further comprise vibration generation means provided in a predetermined internal location of the wireless sensing stick and operated to generate vibration in response to a control signal output from the microcomputer if a frequency generated by the antenna of the road guidance paving block is sensed.

Preferably, the antenna unit of the wireless sensing stick and the coil antenna of the road guidance paving block may be constructed so that they have a transmission or reception distance of 10 to 20 cm therebetween, thus preventing communication interference with other adjacent road guidance paving blocks.

Preferably, the memory unit may be contactless Electrically Erasable Programmable Read Only Memory (EEPROM) or flash memory in which storage, revision or change of location information, direction information and guidance information are facilitated even if power is not supplied to the memory unit.

Preferably, the road guidance paving block may have a surface made of a functional material resistant to predetermined temperatures, pollution, water, bending or impacts.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing the installation of conventional special paving blocks for visually impaired persons;

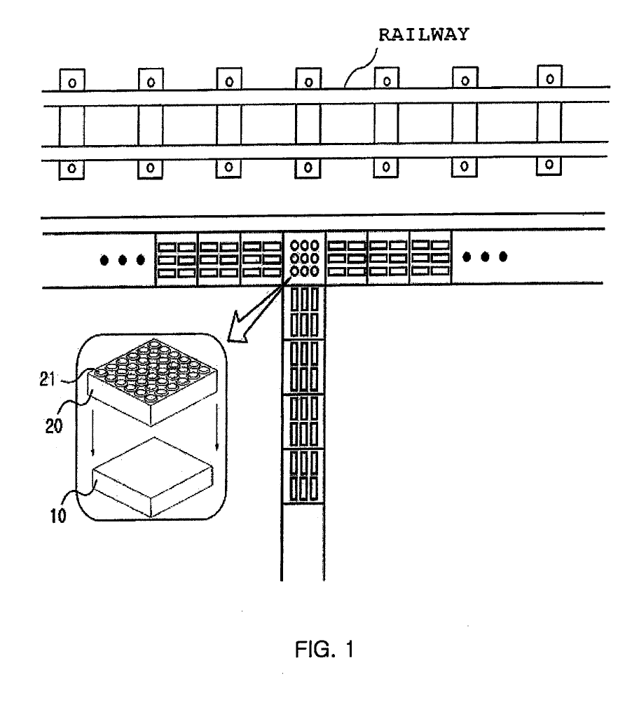

FIG. 2 is a diagram showing the construction of a road guidance system according to the present invention;

FIG. 3 is a block diagram of the road guidance system according to the present invention;

FIG. 4 is a flowchart of a process executed by the road guidance system according to the present invention;

FIG. 5 is a view showing a first embodiment, in which the road guidance system of the present invention is installed on a subway platform;

FIG. 6 is a view showing a second embodiment, in which the road guidance system of the present invention is installed at the corner of a street;

FIG. 7 is a view showing a third embodiment, in which the road guidance system of the present invention is installed at an intersection of an underground passage; and

FIG. 8 is a view showing a fourth embodiment, in which the road guidance system of the present invention is installed at a crossing.

### BEST MODE FOR CARRYING OUT THE INVENTION

Hereinafter, embodiments of the present invention will be described in detail with reference to the attached drawings.

Reference should now be made to the drawings, in which the same reference numerals are used throughout the different drawings to designate the same or similar components.

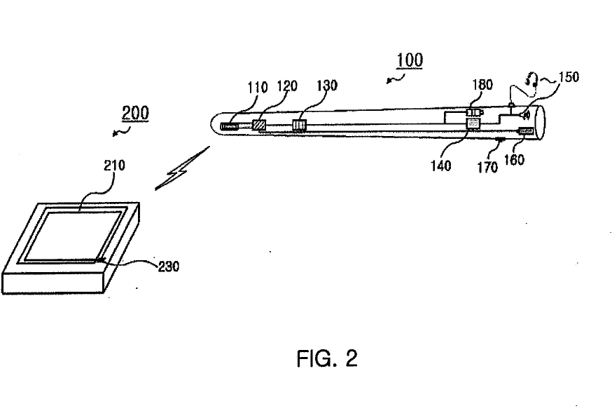

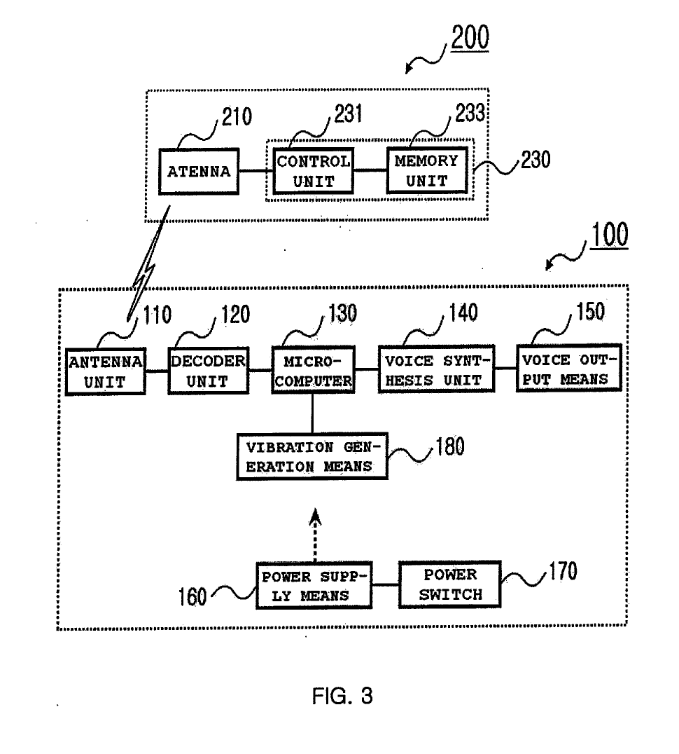

FIG. 2 is a diagram showing a road guidance system according to the present invention, and FIG. 3 is a block diagram of the road guidance system according to the present invention.

As shown in FIGS. 2 and 3, the road guidance system includes a wireless sensing stick 100 and a road guidance paving block 200. The wireless sensing stick 100 includes an antenna unit 110, a decoder 120, a microcomputer 130, a text to speech chipset or a voice synthesis unit 140, a voice output means 150, a power supply means 160, a power switch 170, and a vibration generation means 180.

Meanwhile, the road guidance paving block 200 includes an embedded coil antenna (hereinafter referred to as a “coil antenna”) 210 and an Integrated Circuit (IC) chip 230. The IC chip 230 includes a control unit 231 and a memory unit 233. The coil antenna 210 and the IC chip 230 are preferably installed inside the paving block to perform corresponding functions in order to prevent them from being damaged by external temperature, humidity, and other environmental factors.

The road guidance paving block 200 is supplied with radio waves by the wireless sensing stick 100 through the coil antenna 210 to generate an induced electromotive force, and to use the induced electromotive force as power required for operation thereof. The road guidance paving block 200 functions to read location-related information, which has been previously stored in memory depending on each operation, and to transmit the location-related information to the wireless sensing stick 100 through the coil antenna 210.

The coil antenna 210 embedded in the road guidance paving block 200 functions to receive radio waves from the wireless sensing stick 100 and generate an induced electromotive force, or to transmit location-related information to the wireless sensing stick 100 depending on the induced electromotive force. In FIG. 2, the coil antenna 210 is formed in a rectangular block in the shape of doubled rectangular coils. However, as the shape of the coil antenna 210 in the present invention, various shapes, such as a circular shape, can be used if the shapes are arrangement shapes that optimally transmit or receive radio waves from outside the road guidance paving block. According to the circumstances, the kind of radio wave sensor having the function of the coil antenna 210 can also be used. This structure can be considered to belong to the scope of the present invention.

The IC chip 230 embedded in the road guidance paving block 200 is an IC composed of the control unit 231 and the memory unit 233. The memory unit 233 stores location information and various road guidance information in the form of textual or numerical data. The control unit 231 functions to read the location information and the various road guidance information, stored in the memory unit 233, and to transmit the location information and the various road guidance information to the coil antenna 210 or to control the above information. The control unit 231 also functions to control the transmission of the location information and the various road guidance information.

Preferably, the memory unit 233 is contactless Electrically Erasable Programmable Read Only Memory (EEPROM) in which the storage, revision or change of various data are facilitated even if power is not supplied. If necessary, a scheme in which a flash memory-type storage means is used as the memory unit 233 can also be considered to belong to the scope of the present invention.

The wireless sensing stick 100 provides predetermined radio waves to the road guidance paving block 200, thus activating the road guidance paving block 200. Further, the wireless sensing stick 100 functions to process the location information received from the road guidance paving block 200 through a predetermined process and output road guidance voice information to the voice output means 150. Preferably, respective units 110 to 180, which are suitable for the structure of the stick and will be described later, are installed in the wireless sensing stick 100. The shape of the wireless sensing stick 100 is not limited to a typical stick shape shown in FIG. 2, but can be variously implemented as various shapes, such as a telescopic shape, a hook shape, or a T shape.

The antenna unit 110 of the wireless sensing stick 100 functions to provide a predetermined radio frequency to the coil antenna 210 of the road guidance paving block 200 and generate an induced electromotive force. Further, the antenna unit 110 functions to receive various location information from the road guidance paving block 200 in the form of RF data. Further, in the present invention, the case where a coil antenna is used for the antenna unit 110 is shown, but the antenna unit 110 is not limited to the coil antenna, but can be implemented using any kind of magnetic force sensor having the function of a coil antenna according to the circumstances.

The decoder 120 performs comparison, analysis and decoding on the data received from the antenna unit 110 using a predefined encryption algorithm, and extracts data if the results of the comparison, analysis and decoding are normal.

The microcomputer 130 may function to store a plurality of signal patterns that can be sensed in advance, receive location-related information from the decoder 120 and output a control signal corresponding to the location-related information, and may control the entire system.

The text to speech chipset or The voice synthesis unit 140 functions to convert a location information signal corresponding to the input of a control signal from the microcomputer 130 into a road guidance voice signal, or functions to synthesize the control signal from the microcomputer 130 and road guidance voice signals and output the synthesized voice signals to the voice output means 150.

The voice output means 150 functions to output each road guidance voice signal received from the text to speech chipset or the voice synthesis unit 140 to the outside of the wireless sensing stick 100, and may be implemented using a voice signal or specific tone generation device. The voice output means 150 may be preferably implemented using a sound generation device, such as a buzzer, a speaker or an earphone.

The power supply means 160 functions to supply predetermined power to the microcomputer 130 or respective units. The power supply means 160 may be implemented using a battery, and may be installed inside or outside the wireless sensing stick 100. However, it is effective if the power supply unit 160 is installed inside the wireless sensing stick, so that no unnecessary protrusion is exposed outside of an external shape.

The power switch 170 functions as a switch for manually or automatically adjusting the power supply means 160. As a shape thereof, the power switch 170 may be preferably implemented using a switch having a power ON/OFF function. According to the circumstances, it is preferable that a switch capable of adjusting the amount of power to be supplied by the power supply means 160 be used as the power switch 170.

The vibration generation means 180 generates vibration in response to a control signal received from the microcomputer 130 as a rule. The vibration generation means 180 is provided to perform an auxiliary function of the voice output means 150 and prepare for the case where the transmission of location information is influenced by surrounding noise. Such vibration may be generated as cautionary information vibration, indicating a danger, at places requiring caution, such as a fork (for example, an intersection), a waiting place (for example, a platform), and a starting point (for example, a starting location of stairs). According to the circumstances, the vibration generation means 180 is used together with the voice output means 150, thus providing optimum signal transmission effect to the user.

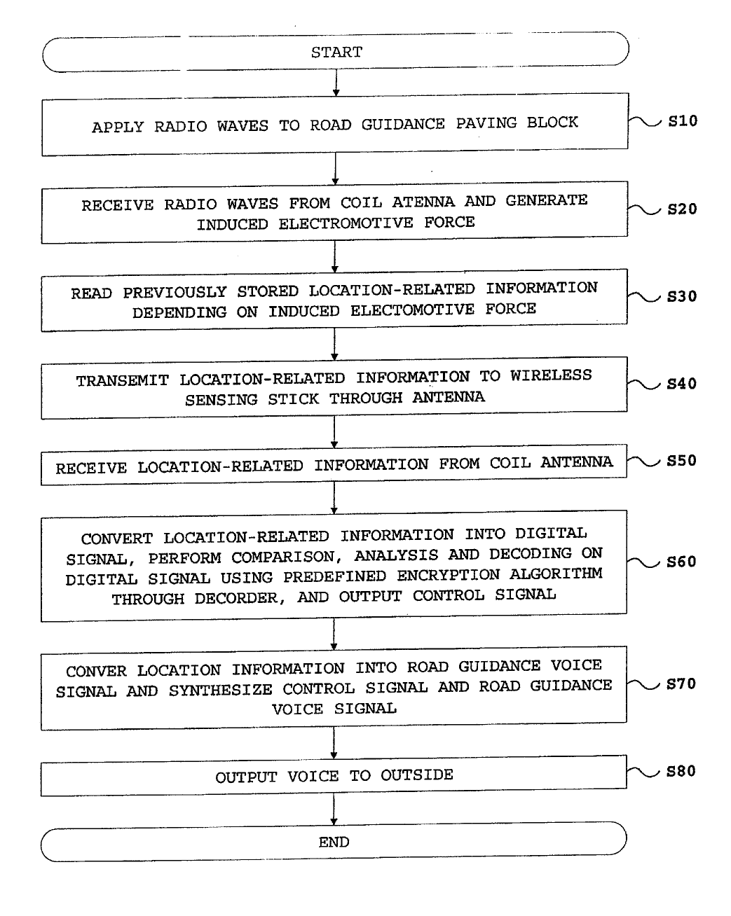

FIG. 4 is a flowchart of a process executed by the road guidance system according to the present invention. As shown in FIG. 4, if predetermined radio waves are provided to the road guidance paving block through the wireless sensing stick at step S10, the road guidance paving block receives the radio waves from the antenna unit of the wireless sensing stick and generates an induced electromotive force at step S20.

The road guidance paving block uses the induced electromotive force as the required power thereof and reads previously stored location-related information at step S30. Then, the road guidance paving block transmits location-related information corresponding to the induced electromotive force to the wireless sensing stick through the coil antenna provided in the road guidance paving block at step S40.

The wireless sensing stick, having received the location-related information at step S50, converts the location-related information, having an analog signal format, into a digital signal, performs comparison, analysis and decoding operations on the digital signal using the decoder, and then outputs a corresponding control signal at step S60. The wireless sensing stick converts the location information into a road guidance voice signal and synthesizes the control signal and the road guidance voice signal at step S70, and then outputs the road guidance voice signal to an external sound output device at step S80.

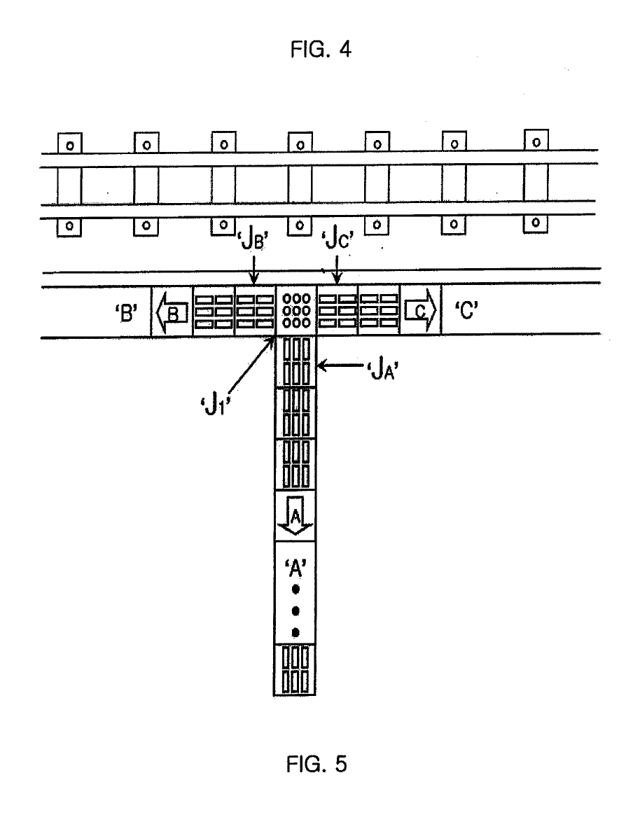

FIG. 5 illustrates a first embodiment, in which the road guidance system of the present invention is installed on a subway platform. In FIG. 5, when the visually impaired person moves in the direction of a location ‘J₁’ from a location ‘A’, the visually impaired person places the wireless sensing stick on a paving block ‘J_{A}’. In this case, the visually impaired person listens to direction information stored in the paving block ‘J_{A}’, and finds out that his/her current location is spaced apart from the location ‘J_{A}’ by a certain distance. If the visually impaired person moves further in the direction of ‘J_{A}’, the visually impaired person places the wireless sensing stick on a paving block ‘J₁’. At this time, the visually impaired person listens to a guidance message (for example, “If you go further, you will be in danger. Please take a step backwards or move to one side.”), changes his or her direction, and then can move in the direction of ‘B’ or ‘C’. Further, the visually impaired person can re-establish his/her traveling direction after placing the wireless sensing stick on paving blocks, disposed in the direction of ‘J_{A}’, ‘J_{B}’, and ‘J_{C}’, at the location ‘J₁’.

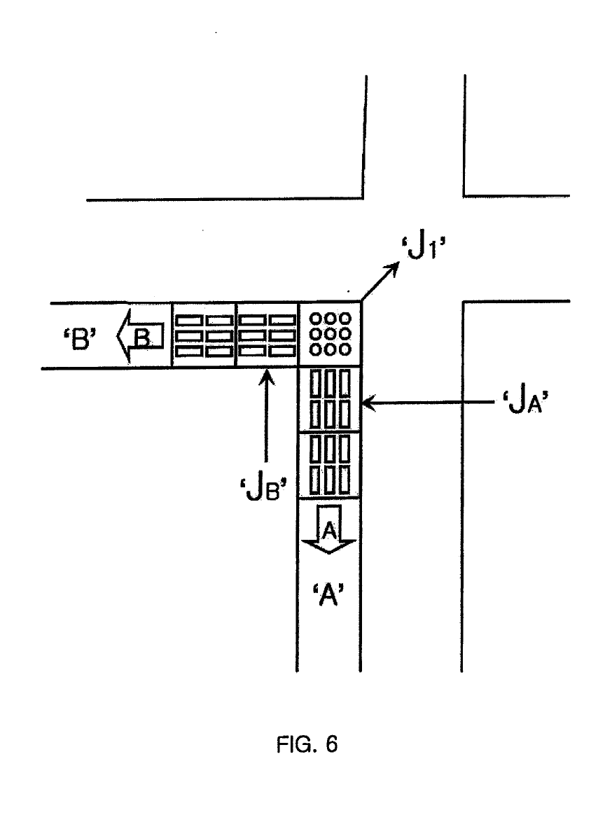

FIG. 6 illustrates a second embodiment, in which the road guidance system of the present invention is installed at the corner of a street. In FIG. 6, when the visually impaired person moves in the direction of a location ‘J₁’ from a location ‘A’, the visually impaired person places the wireless sensing stick on a paving block ‘J_{A}’. In this case, the visually impaired person listens to direction information stored in the paving block ‘J_{A}’, and finds out that his/her current location is spaced apart from the location ‘J_{A}’ by a certain distance. Further, if the visually impaired person moves further in the direction of ‘J_{A}’, the visually impaired person places the wireless sensing stick on a paving block ‘J₁’. At this time, the visually impaired person listens to a guidance message (for example, “this is a street corner”), and can re-establish a traveling direction at the location ‘J₁’.

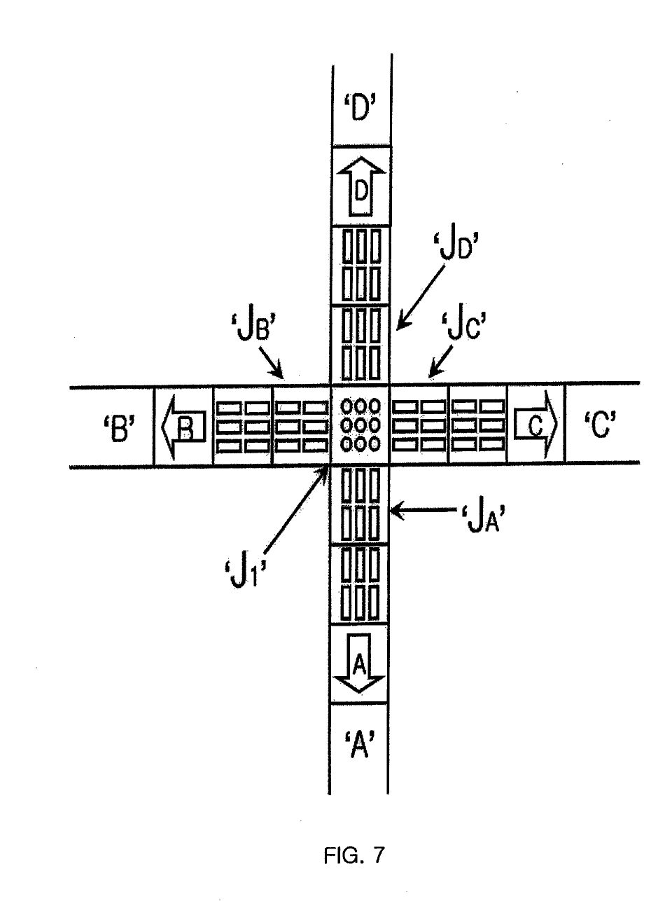

FIG. 7 illustrates a third embodiment, in which the road guidance system of the present invention is installed at an intersection of an underground passage. When the visually impaired person moves in the direction of a location ‘J₁’ from a location ‘A’, the visually impaired person places the wireless sensing stick on a paving block ‘J_{A}’. In this case, the visually impaired person listens to direction information stored in the paving block ‘J_{A}’, and finds out that his/her current location is spaced apart from the location ‘J_{A}’ by a certain distance. If the visually impaired person moves further, the visually impaired person places the wireless sensing stick on a paving block ‘J₁’. At this time, the visually impaired person listens to a guidance message (for example, “This is an intersection”), and can re-establish a traveling direction (‘A’, ‘B’, ‘C’, or ‘D’) after placing the wireless sensing stick on paving blocks, disposed in the directions of ‘J_{A}’, ‘J_{B}’, ‘J_{C}’ and ‘J_{D}’, at the location ‘J₁’.

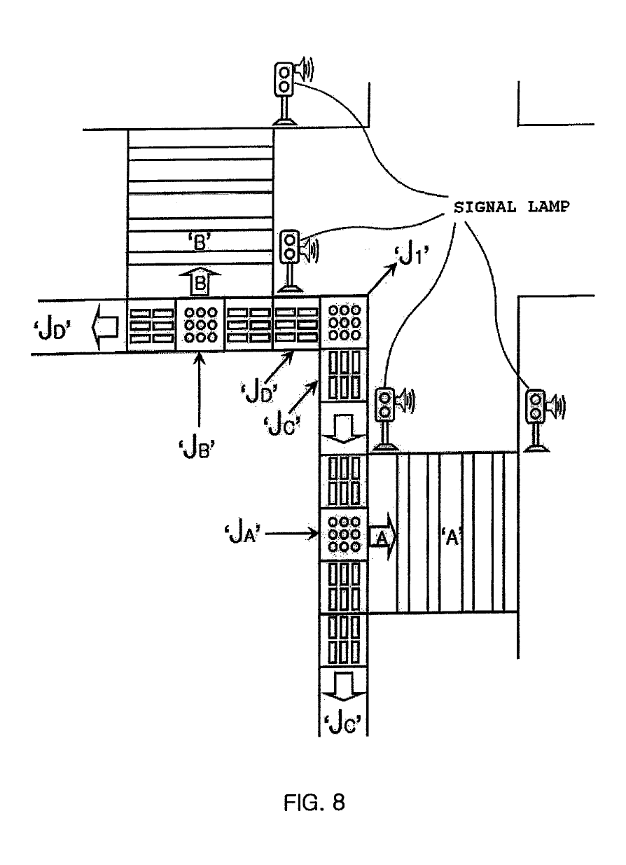

FIG. 8 illustrates a fourth embodiment, in which the road guidance system of the present invention is installed at a crossing. In FIG. 8, when the visually impaired person is at a location ‘J_{A}’, or ‘J_{B}’, the visually impaired person listens to a guidance message from a wireless road sign placed at each location (for example, “This is the crossing at the front of the main entrance of a MokDong girls' high school”). If an indicated road corresponds to the direction of a desired destination, the visually impaired person waits for a pedestrian signal, and crosses a crossing after listening to the signal output from a separately provided signal lamp. If the indicated road does not correspond to a desired destination, the visually impaired person moves to the location ‘J₁’, places the wireless sensing stick on a paving block ‘J_{C}’ or ‘J_{D}’, listens to corresponding direction information, and then waits for a pedestrian signal at a crossing ‘J_{A}’ or ‘J_{B}’, which is situated in the direction of a desired destination.

### INDUSTRIAL APPLICABILITY

As described above, the present invention is advantageous in that it provides information about a traveling direction and information about a specific location to a visually impaired pedestrian, thus notifying the visually impaired pedestrian of information about a current location, and allowing the visually impaired pedestrian to safely walk to his/her destination.

Further, the present invention is advantageous in that it provides a guidance message to a visually impaired pedestrian when the pedestrian enters a dangerous region, thus guiding the visually impaired pedestrian to a safe region.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Such modified embodiments should not be understood as being separate from the technical spirit or scope of the present invention, but should be interpreted as being included in the accompanying claims of the present invention.

1. A road guidance system for visually impaired persons, comprising:
a road guidance paving block for receiving externally applied radio waves through a coil antenna and generating an induced electromotive force, the road guidance paving block reading location-related information, which has been previously stored in memory depending on each operation, and transmitting the location-related information to an outside of the road guidance paving block through the coil antenna; and
a wireless sensing stick for providing predetermined radio waves to the road guidance paving block to induce the road guidance paving block to be activated, receiving the location-related information from the road guidance paving block, processing the location-related information through a predetermined process with text to speech chipset or a voice synthesis unit and then outputting load guidance voice information through voice output means.

2. The road guidance system according to claim 1, wherein the road guidance paving block comprises:
a memory unit operated in response to the induced electromotive force generated through the coil antenna and adapted to store location information that can be output;
the coil antenna installed in the road guidance paving block to receive predetermined radio waves from the wireless sensing stick, generate an induced electromotive force and operate in response to the induced electromotive force; and
a control unit for reading the location information stored in the memory unit, and controlling transmission of the location information to the wireless sensing stick through the coil antenna.

3. The road guidance system according to claim 1, wherein the road guidance paving block comprises:
an antenna unit for transmitting a predetermined radio frequency to the coil antenna of the road guidance paving block to transmit the induced electromotive force, and receiving the location information;
a microcomputer for controlling a decoder, which converts the location information received from the antenna unit into a digital signal and performs comparison, analysis and decoding on the digital signal using a predefined encryption algorithm, and an entire system, and outputting a corresponding control signal if necessary;
a text to speech chipset or a voice synthesis unit for converting the location-related information into a road guidance voice signal and synthesizing the control signal and the road guidance voice signal in response to the control signal from the microcomputer, and outputting the synthesized road guidance voice signal;
voice output means for outputting the road guidance voice signal received from the voice synthesis unit to an external sound output device; and
power supply means for supplying predetermined operating power to the microcomputer.

4. The road guidance system according to claim 3, further comprising an externally controllable power switch placed on a handle or an end portion of the wireless sensing stick and operated so that power supplied to all of the components of the wireless sensing stick can be supplied when the wireless sensing stick comes into contact with the road guidance paving block.

5. The road guidance system according to claim 3, further comprising vibration generation means provided in a predetermined internal location of the wireless sensing stick and operated to generate vibration in response to a control signal output from the microcomputer if a frequency generated by the antenna of the road guidance paving block is sensed.

6. The road guidance system according to claim 2, wherein the antenna unit of the wireless sensing stick and the coil antenna of the road guidance paving block are constructed so that they have a transmission or reception distance of 10 to 20 cm therebetween, thus preventing communication interference with other adjacent road guidance paving blocks.

7. The road guidance system according to claim 1, wherein the memory unit is contactless Electrically Erasable Programmable Read Only Memory (EEPROM) or flash memory in which storage, revision or change of location information, direction information and guidance information are facilitated even if power is not supplied to the memory unit.

8. The road guidance system according to claim 1, wherein the road guidance paving block has a surface made of a functional material resistant to predetermined temperatures, pollution, water, bending or impacts.

9. The road guidance system according to claim 3, wherein the antenna unit of the wireless sensing stick and the coil antenna of the road guidance paving block are constructed so that they have a transmission or reception distance of 10 to 20 cm therebetween, thus preventing communication interference with other adjacent road guidance paving blocks.

10. The road guidance system according to claim 2, wherein the road guidance paving block comprises:
an antenna unit for transmitting a predetermined radio frequency to the coil antenna of the road guidance paving block to transmit the induced electromotive force, and receiving the location information;
a microcomputer for controlling a decoder, which converts the location information received from the antenna unit into a digital signal and performs comparison, analysis and decoding on the digital signal using a predefined encryption algorithm, and an entire system, and outputting a corresponding control signal if necessary;
a text to speech chipset or a voice synthesis unit for converting the location-related information into a road guidance voice signal and synthesizing the control signal and the road guidance voice signal in response to the control signal from the microcomputer, and outputting the synthesized road guidance voice signal;
voice output means for outputting the road guidance voice signal received from the voice synthesis unit to an external sound output device; and
power supply means for supplying predetermined operating power to the microcomputer.

11. The road guidance system according to claim 10, further comprising an externally controllable power switch placed on a handle or an end portion of the wireless sensing stick and operated so that power supplied to all of the components of the wireless sensing stick can be supplied when the wireless sensing stick comes into contact with the road guidance paving block.

12. The road guidance system according to claim 10, further comprising vibration generation means provided in a predetermined internal location of the wireless sensing stick and operated to generate vibration in response to a control signal output from the microcomputer if a frequency generated by the antenna of the road guidance paving block is sensed.

13. The road guidance system according to claim 10, wherein the antenna unit of the wireless sensing stick and the coil antenna of the road guidance paving block are constructed so that they have a transmission or reception distance of 10 to 20 cm therebetween, thus preventing communication interference with other adjacent road guidance paving blocks.
